(19) United States
(12) Patent Application Publication
(10) Pub. No.: US 2014/0326919 A1
(43) Pub. Date: Nov. 6, 2014

(54) Granulated Zeolites With High Adsorption Capacity for Adsorption of Organic Molecules

(71) Applicant: Süd-Chemie IP GmbH & Co.KG, Munich (DE)

(72) Inventors: Ulrich Sohling, Freising (DE); Michael Zavrel, Munich (DE); Michael Kraus, Puchheim (DE); Sandra Hofmann, Roettingen (DE); Sandra Vogel, Ampfing (DE)

(21) Appl. No.: 13/992,641

(22) PCT Filed: Dec. 12, 2011
(86) PCT No.: PCT/EP2011/072472

§ 371 Date: Aug. 19, 2013

(30) Foreign Application Priority Data
Dec. 10, 2010 (DE) 10 2010 054 069.2
Jun. 10, 2011 (DE) 10 2011 104 006.8

(51) Int. Cl. B01J 39/26; B01D 15/00; B01D 53/04

(52) U.S. Cl. CPC B01J 39/26; B01D 53/04; B01D 15/00
USPC 252/184; 423/245.1; 210/681

(57) ABSTRACT

The invention relates to granulated zeolites with high adsorption capacity for organic molecules and the use of the zeolites for adsorbing organic molecules from liquids or gas streams.

The invention relates to granulated zeolites with high adsorption capacity for organic molecules and to the use of the zeolites for adsorbing organic molecules from liquids or gas streams.

Biofuels such as bioethanol for example have a favourable CO₂ balance and are becoming increasingly important as substitutes for fossil fuels. “Bioethanol” denotes ethanol that has been produced exclusively from biomass (renewable carbon carriers) or from biodegradable components of wastes and is intended for use as biofuel. If the ethanol is produced from plant wastes, wood, straw or whole plants, it is also called cellulose ethanol. Ethanol fuels are used as energy carriers in internal combustion engines and fuel cells. In particular, use as a gasoline substitute or additive in motor vehicles and recently also aircraft engines has become more important in recent years mainly because of the problems that are becoming more and more evident in connection with fossil fuels.

The currently usual production from starch and sugar cane will not be able to meet the increasing demand for bioethanol. The limited availability of cultivable land, ecological problems in the necessary intensification of agriculture and competition with the food market limit the production of bioethanol in this conventional way.

In the context of international price rises for raw materials and foodstuffs and owing to the problems arising from this, the role of bioethanol as competition for food production has also been examined. Particularly in the manufacturing countries, the use of arable plants, which also serve for food production, had led to a rapid increase in food prices, as indigenous purchasers are in direct competition with bioethanol buyers in the western industrial nations. In Mexico this has already led to state price controls for maize by emergency decree, as this is being processed on a large scale to ethanol for North American motor vehicles.

The cultivation of energy plants, which actually serve for food production, has already often been described as a threat to feeding the world population. For example, from 100 kg of cereal it is possible to produce about 100 kg of bread, but only 25 litres of bioethanol. With the harvest from one hectare of cereal area, about 18 people can be fed for one year, or bioethanol can be produced for one vehicle with an average consumption and moderate mileage for one year. Thus, the operation of one vehicle consumes as much cereal as is required for feeding 18 people.

One alternative is to use crops that are unsuitable for human nutrition or plant wastes. These materials, consisting mainly of cellulose, hemicellulose and lignin, are produced in large quantities (often even as waste products), for example in the production of edible oils or the processing of sugar cane. These raw materials are cheaper than starch-rich or sugar-rich agricultural raw materials. Moreover, the potentially usable biomass per unit area is higher, the CO₂ balance is more positive and cultivation is sometimes much more environment-friendly.

Ethanol produced from plant wastes is called cellulose ethanol or lignocellulose ethanol. In contrast to the conventional bioethanol, cellulose ethanol has a better CO₂ balance and is not in competition with the food industry. The aim is to convert, in so-called biorefineries, cellulose and hemicellulose into fermentable sugars such as glucose and xylose and have them fermented by yeasts directly to ethanol. The lignin could be used as fuel for driving the process. In biotechnological processes of this kind, bioethanol is produced in a mixture with water. When microorganisms are used that are able to ferment all the sugars that occur, and in particular sugars that consist of five carbon atoms such as xylose, the attainable ethanol concentration is very low. For example, Dominguez et al. (Biotech. Bioeng., 2000, Vol. 67, p. 336-343) were able to show that the reaction of C5-sugars to ethanol with the yeast Pichia stipitis is inhibited at just 2% (w/v) ethanol. With these low ethanol concentrations, the energy expenditure for distillation is so high that separation of the ethanol by distillation is therefore ruled out. However, to date, no methods are known in the state of the art for production of lignocellulose ethanol, by which economical production and particularly effective, sustainable and energy-saving purification are made possible.

Adsorbents based on zeolites with their specific properties, such as high chemical and thermal resistance, the existence of a regular channel and pore system in the subnanometre range and the development of specific interactions with adsorbed molecules owing to a variable cationic composition, are already used in industrial processes.

Thus, zeolites are used in the area of drying of gases or liquids, in particular in the area of air separation (cryogenic or non-cryogenic) and here in particular adsorbents based on faujasite zeolite (type X). The term “faujasite zeolite” denotes a class of crystalline aluminosilicates, which also occur as natural mineral. However, only the synthetic products with faujasite structure are of economic importance. Within these zeolites with faujasite structure, there has been further classification according to composition (especially based on the SiO₂/Al₂O₃ molar ratio). Thus, products with SiO₂/Al₂O₃ of more than 3.0 are called Y-zeolites, and those with SiO₂/Al₂O₃ of less than 3.0 are called X-zeolites.

A drawback of classical zeolite types (type A and in particular faujasite) is that they are sensitive to thermal (hydrothermal) treatment. Owing to thermal stresses, particularly in the presence of steam, the crystalline structure of the zeolites and therefore also their properties can be altered fundamentally. If using zeolite granules, another disadvantage is that the binder necessary for the stability of the granules exerts no action as adsorbent. Therefore the thermal decomposition of the pore forming agents must be carried out in such a way that thermal/hydrothermal stressing of the granules is avoided, which means additional effort. The problems of thermal loading even affect the hardening of the traditionally used mineral binders (such as e.g. attapulgite), which—in order to be able to produce formed articles that are resistant to compression and abrasion—must undergo a temperature treatment in the range of from 500 to 600° C. (e.g. U.S. Pat. No. 6,743,745).

However, for the methods described above to be carried out on a large scale, it is necessary to transform corresponding zeolite powder into granules, in order to keep the pressure losses in the corresponding adsorber columns within acceptable limits. For this, the corresponding granules must on the one hand have sufficient mechanical stability, and on the other hand appropriate formulation must prevent a sharp drop in the adsorption capacity of the zeolites due to the binder, in comparison with the corresponding powders. Furthermore, the granules should adsorb as little water as possible, which requires binders with reduced binding of water. Against this background, granules with hydrophilic binders such as aluminium oxide for example are not suitable. During the sintering process, the hydrophobicity of the zeolites should not be reduced by incorporation of aluminium from the binders into the zeolite structure.

A number of processes are known from the state of the art, by which zeolite powders can be transformed into granules with sizes from 100 μm up to several millimetres. These firstly comprise a granulation process with binders, which are generally of an inorganic nature, a drying process at temperatures between 80 and 200° C. and a sintering process at temperatures from 400 to 800° C. Known techniques are used as granulation processes. On the one hand this can be pelletizing, in which the powder mixture is pelletized by means of a liquid using a so-called balling disk. Furthermore, forming can be carried out by extrusion and then comminution. Finally, granulation can also be carried out by means of a mechanically generated fluidized bed.

DD 0154009 describes a method of producing dust-free zeolite granules with high abrasion resistance by mixing sodium zeolite powder with kaolinite clay in the proportions 70-60 to 30-40, granulation and calcining at 500-550° C., followed by postcrystallization and calcining again at 500-550° C., characterized in that the postcrystallization is carried out in the crystallization mother liquor that results from the production of the sodium A-zeolite. Both the adsorption capacity of the granules and the strength are said to be increased by the postcrystallization.

DD 268122 A3 describes a method of producing molecular sieve granules, by which granules can be produced that possess both good adsorptive properties and mechanical properties. According to the invention, these granules are produced by mixing a montmorillonite-rich and a kaolinite-rich clay as binders together with the molecular sieve powder with addition of water, drying and calcining. In this invention it was found that the proportion of the montmorillonite-rich clay must be of the order of 5-30% and that of the kaolinite-rich clay in the binder must be in the range of 95-70%.

DD 294921 AS describes the use of a zeolitic adsorbent with improved adsorption kinetics. This relates to a use for adsorption of water and steam in insulating glasses and not to the binding of organic molecules as in the present invention.

DD 121092 describes a method of producing zeolite granules with improved dynamic adsorption capacity while retaining the known high mechanical strength. Clays with a BET surface area between and 40 m²/g are used as binders for the zeolite granules. After mixing the zeolite powder with the binder, the mixture is plasticized with water in a kneader and is formed in an extruder to strands with diameters of 3 mm. The strands are dried and calcined at 600° C. for 6 h. According to the information in this document (page 3), granulating with clays with high swelling capacity, for example illite and montmorillonite clay minerals, is unfavourable, because although these produce excellent mechanical strength in the granules, they lead to impaired dynamic adsorption capacity. “Dynamic adsorption capacity” means the amount of adsorbate with which a molecular sieve bed that is present in the adsorber, and through which a gas or liquid stream containing the adsorbate flows, is at maximum loading, if at a defined flow rate the adsorbate concentration at the adsorber outlet should not exceed a specified value.

WO 8912603 describes a process for producing zeolite agglomerates for molecular sieves, in which the binder is itself a zeolite. In this process, a paste is prepared from a zeolite powder, a silica sol and a sodium aluminate solution. This is extruded, left to mature at room temperature, and then heat-treated and calcined. In this production process, the corresponding zeolite is said to form from the silica sol and the sodium aluminate. The process comprises drying at 50-100° C. and calcining at temperatures between 450 and 600° C.

EP 0124736 B1 describes silicate-bound zeolite granules and a method of production thereof and use thereof. The process is characterized in that a complete exchange of the sodium ions in the binder, which is usually water glass, with other metal cations is carried out, wherein the zeolite contains a cation that is not present in the binder. The usual procedure is for the zeolite to be granulated first with water glass, dried and sintered. Next, through ion exchange, magnesium is introduced into the granules. For this, the granules are packed in a column. Then there is another drying and calcining step. This method is too expensive to be used generally for producing various zeolite granules or sizes.

DE 3208672 A1 describes an abrasion-resistant, granular zeolite and a method of production thereof. The zeolite granules are characterized in that they consist of a core and a shell, wherein core and shell contain different proportions of zeolite and alumina binder. Granule production is carried out as is known from the state of the art, i.e. firstly forming, secondly drying for 3 h at 100-150° C. and thirdly sintering for 3 h at 550±30° C. It is stated that the end product has excellent zeolitic properties such as adsorption capacity and ion exchange capacity, and excellent mechanical properties such as abrasion resistance and compressive strength. Essentially water adsorption has been investigated as an application. It is not a case of adsorption of organic molecules from the gas phase.

EP 0124737 B1 claims magnesium-bound zeolite granules of the zeolite A type and a method of production thereof and use thereof. The granules are characterized in that they adsorb organic gases. Protection covers granules of zeolite A, which were produced according to the aforementioned invention EP 0124736 B1.

U.S. Pat. No. 6,264,881 B1 describes a method of producing LSX-zeolite agglomerates. It describes a process for producing faujasite-X agglomerates, which contain at least 95% faujasite-LSX (Si/Al ratio=1). The granules are produced from LSX zeolite and a binder, which consists of Laponite (synthetic hectorite). According to the examples, the granules that are formed with 10% Laponite have a far higher adsorption capacity for oxygen and nitrogen than those that are produced with 15% attapulgite clay as binder.

EP 1468731 A1 describes a method of producing formed zeolites and methods of removing impurities from a gas stream. In this case it is a formed zeolite based on a faujasite of type 13× or of type LSX or a mixture of both types. These are processed into granules, with a binder that is partly highly dispersed. According to claim 1, the binder is attapulgite. After forming, the raw zeolite bodies or granules are dried and calcined. The bulk density of the granules is >550 g/l, and according to claim 3 the proportion of binder in the finished adsorbent is between 3 and 30 wt.-%. The binder can, however, also contain 10-90% of a conventional clay binder. It is argued that the special granule formulation is suitable in particular for purifying gaseous streams to remove water vapour and carbon dioxide as impurities, wherein the special granule formulations have a long life and extraordinarily high adsorption capacities.

WO 0001478 describes an adsorbent consisting of a molecular sieve for purifying gases and a method of production of this adsorbent. The granules are based on the sodium form of a low-silica faujasite, which contains a silicon/aluminium ratio from about 1.8 to 2.2 with a residual potassium content of less than 8% and a binder. The granules are to be used for removing carbon dioxide and water from gases.

WO 03061820 A2 describes a process for producing molecular sieve-based adsorbents. These are based on mixtures of zeolites and highly dispersed attapulgites. The formed product is used for purifying gases or liquids. The field of application for gas purification is use in so-called pressure swing adsorption (PSA) and temperature swing adsorption (TSA). The pore size of the formed product is also increased by adding organic materials, which burn away without residue during the sintering process, for example sisal, flax, maize starch, lignosulphonates, cellulose derivatives etc. The formed product is used in the drying of gas product streams, for example gaseous ethanol, in the separation of nitrogen from air streams and in the separation of sulphur-containing or oxygen-containing compounds from hydrocarbon streams. Another application mentioned is the removal of carbon monoxide, carbon dioxide and nitrogen from hydrogen gas streams.

WO 2008/152319 A2 describes spherical agglomerates based on zeolites and a process for production thereof and use thereof in adsorption processes or in catalysis. In this case protection covers agglomerated zeolites, which have a zeolite content of at least 70, preferably at least 80, particularly preferably at least 90 wt.-%, wherein the rest of the composition consists of an inert material. The zeolites are characterized according to claim 1 by D50 values<600 μm, a bulk density of 0.5-0.8 g/cm³ and further properties, which are presented in claim 1. Claim 2 restricts the composition to the use of zeolite A, faujasite, zeolite X, Y, LSX, chabasite and clinoptilolite. According to claim 3 the inert material is consisting of a clay or a clay mixture. A wide range of clays is mentioned. The granules are produced on a balling disk. Finally they are dried and sintered at 550° C. for 2 h.

WO 2008/009845 A1 describes agglomerated zeolite adsorbents, a method of production thereof and applications thereof. This document relates essentially to granulation of zeolite X with a silicon/aluminium ratio in the range of 1.15<Si/Al≦1.5. The applications mentioned include the adsorption of para-xylene in C8 aromatics, hydrocarbon fractions and liquids, but also the separation of sugar, polyols, cresols and substituted toluene isomers.

WO 2009/109529 A1 describes a granulated adsorbent based on X-zeolite with faujasite structure and an SiO₂/Al₂O₂ molar ratio of ≧2.1-2.5, wherein the granules have an average diameter of the transport pores of >300 nm and a negligible proportion of mesopores and wherein the mechanical properties of the granules are at least equal to or better than the properties of X-zeolite-based granules formed using an inert binder, and the equilibrium adsorption capacities for water, CO₂ and nitrogen are identical to those of pure X-zeolite powder of comparable composition.

The object to be achieved by the present invention was to provide granules for the adsorption of organic molecules from gases and liquids, which are sufficiently stable even for industrial column packings, and have a high adsorption capacity for the target molecules, but at the same time low adsorption capacity for water.

It was found, surprisingly, that such granules can be produced from a zeolite and certain clay mineral(s) as binder.

The present invention therefore relates in a first aspect to granules comprising at least one zeolite and at least one clay mineral with a cation exchange capacity of at most 200 meq/100 g, wherein the proportion of monovalent ions in the cation exchange capacity of the at least one clay mineral is at most 50%. It was found, surprisingly, that the proportion of exchangeable divalent cations, in particular Ca²⁺ and Mg²⁺ in the clay mineral has advantageous effects on the adsorption capacity.

Granules that comprise at least one zeolite and at least one clay mineral with a cation exchange capacity of less than 200 meq/100 g, wherein the proportion of monovalent ions in the cation exchange capacity of the clay mineral is less than 50%, are particularly suitable for achieving the object according to the invention.

The zeolite used in the context of the present invention can be any zeolite that is known by a person skilled in the art to be suitable for the purpose according to the invention. Those that are particularly suitable and preferred are hydrophobic zeolites, in particular zeolites with an SiO₂: Al₂O₃ ratio of at least 20, preferably at least 100, more preferably at least 200, particularly preferably at least 350 and most preferably at least 500. Moreover, it is also possible for the granules to comprise two or more different zeolites. These can be present in identical or different proportions. Particularly preferred zeolites are zeolites selected from the group consisting of β-zeolite, silicalite, mordenite, Y-zeolite, USY, ferrierite, erionite, MFI zeolite and mixtures thereof. Preferred combinations were for example those from MFI zeolite and beta-zeolite.

Preferred zeolites have an average pore size of at least 3.5 Å and at most 10 Å, preferably at least 4 Å and at most 8 Å, and most preferably at least 5 Å. Preferred zeolites have, even more preferably, an average channel and supercage size of at least 1 Å and at most 20 Å. Moreover, it is possible for the average pore size of the zeolites to be at most 20 Å, preferably at most 10 Å and particularly preferably at most 7 Å.

The clay mineral used can be any clay mineral that meets the requirement of a cation exchange capacity of at most 200 meq/100 g, wherein the proportion of monovalent ions in the cation exchange capacity of the clay mineral is at most 50%. Clay minerals are particularly preferred that have a cation exchange capacity of at most 150 meq/100 g, more preferably of at most 100 meq/100 g, even more preferably of at most 80 meq/100 g, particularly preferably of at most 60 meq/100 g, more preferably of at most 50 meq/100 g and most preferably of at most 40 meq/100 g. Moreover, it is possible for the cation exchange capacity of the clay mineral to be at least 5 meq/100 g, preferably at least 10 meq/100 g, more preferably at least 15 meq/100 g and most preferably at least 20 meq/100 g.

Moreover, it is further preferred if the proportion of monovalent ions in the cation exchange capacity is at most 60%, preferably at most 45%, more preferably at most 35%, even more preferably at most 30%. Clay minerals are particularly preferred that have a cation exchange capacity of at most 110 meq/100 g and a proportion of monovalent ions in the cation exchange capacity of at most 20%. Moreover, it is possible for the proportion of monovalent ions in the cation exchange capacity to be at least 1%, preferably at least 5%.

The proportion of divalent cations, in particular of calcium ions in the cation exchange capacity of the clay mineral is in this case preferably at least 40%, more preferably at least 40%, particularly preferably at least 50%, more preferably at least 60% and most preferably at least 70%. Moreover, in further embodiments it is possible for the proportion of divalent cations, in particular of calcium ions, to be at most 99% or at most 90%.

Furthermore, in the context of the present invention it is particularly preferable if the proportion of sodium ions in the cation exchange capacity is at most 25%, more preferably at most 15%, even more preferably at most 5% and most preferably at most 1%. Moreover, it is possible for the proportion of sodium ions in the cation exchange capacity to be at least 0.01% or at least 0.1% or even at least 1%. It is also preferable if the clay mineral is free from exchangeable sodium ions.

Granules are particularly preferred in which the at least one clay mineral has a ratio of divalent ions Ca²⁺ and Mg²⁺ to monovalent ions, as the sum of Na⁺+K⁺+Li⁺, determined from measurements of the cation exchange capacity, that is between 1:2 and 20:1.

Moreover, in the context of the present invention it is preferable if the at least one clay mineral is a sheet silicate. Basically, in the context of the present invention it is possible to use any sheet silicate that fulfils the requirement of a cation exchange capacity of at most 200 meq/100 g and a proportion of monovalent ions in the cation exchange capacity of at most 50%. Smectic sheet silicates, such as montmorillonite, aliettite, corrensite, kulkeite, lunijianlaite, rectorite, saliotite, tarasovite, tosudite, beidellite, brinrobertsite, nontronite, swinefordite, volkonskoite, yakhontovite, hectorite, ferrosaponite, saponite, sauconite, spadaite, stevensite, zincsilite and mixtures thereof, are particularly preferred. Moreover, it is also possible for the granules to comprise two or more different clay minerals. These can be present in identical or different proportions. For example, combinations of saponites and montmorillonites can be used.

Other preferred sheet silicates that can be used for producing the granules according to the invention are those in the talc-pyrophyllite group. Examples are talc, pyrophyllite and kerolite. Finally, sheet silicates that are mixtures or alternate-bedding minerals of sheet silicates of the talc-pyrophyllite group and smectic sheet silicates are also preferred. An example is provided by the kerolite-stevensite clays, as described in J. L. de Vidales et al., Kerolite-Stevensite Mixed-Layers from the Madrid Basin, Central Spain, Clay Minerals (1991) 26, 329-342. Ratios of kerolite to stevensite from 3:1 to 1:3 are preferred. Alternatively, clay minerals can be used that consist of mixtures of saponite and kerolite, wherein their ratio is preferably between 3:1 and 1:3.

In particularly preferred embodiments, the sheet silicate is a mineral in the talc-pyrophyllite group. It is also particularly preferable if the sheet silicate is a natural or artificial mixture of a clay of the talc-pyrophyllite group and a smectic clay.

Furthermore, according to a special embodiment of the present invention it is preferable if the proportion of the clay mineral in the granules is overall at most 20 wt.-%, preferably at most 15 wt.-%, more preferably at most 10 wt.-%, even more preferably at most 5 wt.-%. Moreover, it is possible for the proportion of the clay mineral in the granules to be at least 0.01 wt.-%, preferably at least 1 wt.-%, more preferably at least 3 wt.-% and particularly preferably at least 5 wt.-%.

The granules of the present invention preferably have an average size from 1 to 7 mm, preferably from 2 to 6 mm and particularly preferably from 3 to 5 mm. The “average size” is determined by sieve analysis. Particularly preferably the distribution is monomodal.

It is also preferable for the granules of the present invention to have a D50 value of at least 0.5 mm, preferably at least 1 mm, more preferably at least 1.5 mm and most preferably at least 2 mm.

Furthermore, in the context of the present invention it is preferable if the granules have a BET specific surface from 150 to 600 m²/g, preferably 200 to 500 m²/g and most preferably from 250 to 400 m²/g.

These granules are produced by processes that are known per se: pelletizing on a balling disk, extrusion or granulation in a mechanically generated fluidized bed, followed by a drying process and a sintering process. The use of granulation by means of a mechanically generated fluidized bed in an intensive mixer, such as that made e.g. by the company Eirich, Hartheim, Germany, is particularly preferred. Alternative mixing units are available for example from the companies Lödige or Ballestra. For granulation, the at least one zeolite is prepared with the at least one binder and then granulated with water. The drying process is followed by sieving to the target particle size, after which sintering is carried out at min. 300° C. and max. 1000° C., preferably between 500° C. and 800° C. for at least 10 minutes and at most 5 h.

Preferably the granules have the smallest possible proportion of mesopores (pore diameter<50 nm) and an average pore diameter that is as large as possible (D. Bathen, M. Breitbach: Adsorptionstechnik [Adsorption technology], Springer Verlag 2001, 13, cf. WO 2009-109529). A high proportion of macropores is desirable.

The porosity of the granules can be determined for example by nitrogen porosimetry. Using the BJH method, usually pores with diameters from 1.7 to 300 nm can be detected (I. P. Barret, L. G. Joiner, P. P. Haienda, J. Am. Chem. Soc. 73, 1991, 373).

The proportion of mesopores and macropores is usually determined by mercury porosimetry (DIN 66133, Meso- and macropore distribution from 900 μm to 3 nm), cf. A. W. Adamson, A. P. Gast, Physical Chemistry on Surfaces, Wiley (1997) p. 577 and F. Ehrburger-Dolle, Fractal Characteristics of Silica Surfaces and Aggregates in The Surface Properties of Silicas, Editor A. P. Legrand, Wiley (1998) p. 105.

Mercury, as a non-wetting liquid, is forced into the pores, wherein the large pores are filled first, and the smaller pores are only filled at high pressures. The relationship between pressure and pore radius is described by the so-called Washburn equation (see references cited above).

Besides the pore radius distribution, it is possible in this way to determine the pore volume, the porosity and the specific surface of the sample. Mercury porosimetry can be regarded as a supplementary method to gas sorption.

Furthermore, it is preferable for the binding capacity for the organic (target) molecules, for example ethanol, acetone or butanol from the gas phase to be at least 80%, particularly preferably 90% of the binding capacity, relative to the initial weight of zeolite, as can be measured for the corresponding starting powder of the zeolite. The granules according to the invention preferably adsorb at most 20% (w/w) more water compared to non-granulated zeolites.

Furthermore, in the context of the present invention it is preferable if the granules comprise a proportion of a metallic material that is particularly preferably in the range of from 0.001 to 30 wt.-%, more preferably 0.01 to 20 wt.-% and particularly preferably in the range of from 5 to 10 wt.-%.

An admixture of metallic material has the advantage that adsorbed molecules can be adsorbed and desorbed more effectively, i.e. in particular the adsorption and/or desorption time can be decreased. As a result, for example the cycle time can be shortened. This also makes it possible to reduce the size of the adsorption column, which in turn offers the further advantage that a smaller height of packing can be employed and the pressure loss is thus reduced. As a result, the process also requires less energy overall.

Furthermore, an admixture of metallic material has the advantage that granules that contain an admixture of metallic material have greater stability. This is of advantage in particular when using adsorbent granules in the up-flow mode of operation, i.e. with an ascending gas stream, as fluidization of the particles is hampered.

The aforementioned advantages that can be achieved with an admixture of certain amounts of metallic material can, besides the granules according to the invention, be achieved with any type of composite material, such as in particular granules that are used for adsorption and/or desorption processes.

Possible composites in which an admixture of metallic material leads to one of the aforementioned advantages are composites comprising at least one zeolite.

Basically, with these composites it is possible to use all zeolites that a person skilled in the art knows to be suitable. The zeolites can moreover be used in pure form or as a mixture of two or more zeolites. Hydrophobic zeolites are preferred, and zeolites with an SiO₂/Al₂O₃ ratio of at least 100, preferably of at least 200, more preferably of at least 500 and quite particularly preferably of at least 800 are particularly suitable. Particularly preferred zeolites are selected from the group consisting of silicalite, beta-zeolite, mordenite, Y-zeolite, MFI zeolite, ferrierite, dealuminated, ultrastable zeolite Y (USY) and erionite. In addition, mixtures of the aforementioned zeolites in any proportions can be used.

The zeolites are used in the form of a zeolite powder and particularly preferably have a particle size between 0.5 and 100 μm, preferably between 1 and 50 μm and particularly preferably between 5 and 25 μm.

The proportion of the zeolite or zeolites is preferably 1 to 99 wt.-% (relative to the total weight of the composite material or granules), more preferably 10 to 90 wt.-%, even more preferably 20 to 85 wt.-%, particularly preferably 40 to 80 wt.-% and most preferably 50 to 75 wt.-%.

In a particularly preferred embodiment the composite material additionally comprises a binder. The binders used can be any substances that a person skilled in the art knows to be suitable. Particularly preferred binders are clay minerals, or silicon-containing substances. The clay minerals are preferably sheet silicates, particularly preferably smectic sheet silicates or a mineral from the talc-pyrophyllite group or mixtures thereof. The silicon-containing substances are preferably silicon dioxide, derivatized silicon dioxide, precipitated silica, water glass or silica sol. However, it is also possible to use binders from the group of clay minerals and/or from the group of silicon-containing substances of a composite material. Mixtures of various binders are also possible.

The proportion of the binder is preferably 0.01 to 45 wt.-% (relative to the total weight of the composite material or granules), more preferably 1 to 40 wt.-%, even more preferably 2 to 35 wt.-%, particularly preferably 3 to 30 wt.-% and most preferably 5 to 20 wt.-%.

The composite material contains a metallic material. This is preferably metals or metal alloys, preferably bronze, gold, tin, copper or special steels, i.e. steels with a low sulphur and phosphorus content. Steel with the material number 1.431 is particularly preferred. The metallic material is preferably in the form of a wire composite, a perforated plate, in the form of swarf or metal wool or in powder form. The powder form is particularly preferred.

The metal powder particle size is preferably in the range of from 25 to 150 μm, more preferably in the range of from 45 to 75 μm. A metal powder with the following particle size distribution is particularly preferred: particles >150 μm: 0 wt.-%; particles 45-75 μm 80 wt.-% and particles >75 and ≦150 μm: 2 wt.-%.

A process by which particularly advantageous composites can be produced comprises the following steps
a) providing a composition comprising at least one zeolite;
b) adding at least one metallic material to the composition;
c) contacting the composition according to step b) with at least one granulating agent, for example water;
d) forming a composite material.

As granulating agent, it is possible to use all granulating agents that a person skilled in the art knows to be suitable. Preferred granulating agents are water, water glass, aqueous solutions of polymers for example polyacrylates, polyethylene glycols; alkanes, mixtures of alkanes, vegetable oils or biodiesel. The granulating agent is furthermore preferably used in a proportion of from 0.1 to 60 wt.-% (relative to the total amount of the composition), preferably from 1 to 50 wt.-%, more preferably from 5 to 40 wt.-%, particularly preferably from 10 to 35 wt.-% and most preferably from 15 to 30 wt.-%.

For the terms such as “zeolite” and “metallic material” used in the context of the process, the aforementioned definitions and preferred embodiments apply.

In the context of a particularly preferred process, moreover a binder is added to the composition before adding the granulating agent. Preferred binders are also described above.

Production is further explained below for the example of granules. Application to the production of other formed products is known by a person skilled in the art.

### Production of Granules

Granulation is carried out using the composition of hydrophobic zeolite, clay minerals or silicon-containing substances and metal powder. Said granules are produced by the known processes of pelletizing, extrusion or granulation in a mechanically generated fluidized bed, followed by a drying process and a sintering process. It is particularly preferable to use granulation by means of a mechanically generated fluidized bed in an intensive mixer, such as that made for example by the company Eirich, Hartheim, Germany. Alternative mixing units are available for example from the companies Lödige or Ballestra. For granulation, the zeolite is prepared with the binder and metal powder and is then granulated with water. The drying process is followed by sieving to the target particle size, and then sintering at at least 500° C. for at least 30 minutes.

Preferred granules are characterized by D50 particle sizes of at least 0.5 mm, preferably >1 mm, particularly preferably >1.5 mm. Furthermore, they are characterized in that the binding capacity for the low-molecular target molecules, for example ethanol, acetone or butanol, from the gas phase is at least >80%, particularly preferably >90% of the binding capacity, relative to the initial weight of zeolite, as can be measured for the corresponding starting powder. Preferred granules adsorb max. 20% (w/w) more water and preferably less water compared to the non-granulated zeolites.

This can be adjusted as required by the selection of the clay minerals and the process conditions. Thus, for the clay minerals, smectic clays are preferred, in particular montmorillonites. Montmorillonites with a proportion of monovalent ions in their cation exchange capacity of less than 50% are quite particularly preferred. Investigations suggest that a calcium bentonite can be adapted particularly favourably for achieving an open-pore structure in the zeolite granules and thus promote the penetration of the target molecules, relative to granules for which a natural sodium bentonite or one obtainable by soda activation was used.

Instead of clay minerals, it is also possible to use silicon-containing substances. Mixtures of silicon-containing substances and clay minerals are also possible.

These preferred composites comprising a metallic material, as described above, can be used particularly advantageously for adsorption and desorption.

These processes, for which the use of the composites described in more detail above is particularly advantageous, are explained in more detail below.

a. Adsorption

In adsorption, a gas stream that contains the volatile organic compounds flows through one or more adsorption units, preferably fixed-bed columns, which contain the composite material. During this, at least one of the volatile organic compounds is removed from the gas stream by adsorption.

Preferably the gas stream is enriched with the volatile organic compounds by gas-stripping of an aqueous solution, preferably a fermentation solution. Particularly preferably this enrichment takes place in situ, i.e. while the volatile organic compounds are formed.

b. Desorption

Desorption takes place at reduced pressure. The absolute pressure is preferably below 800 mbar, more preferably below 500 mbar, even more preferably below 200 mbar and quite particularly preferably below 100 mbar.

When using the composite material, preferably no additional heat input is required, because after adsorption the material has already stored heat. However, it is also possible to supply heat by magnetic induction.

The use of the composites described in more detail above is particularly suitable for the adsorption and/or desorption of organic molecules. The organic molecules that can be adsorbed particularly advantageously include molecules from one or more of the substance classes of alcohols, ketones, aldehydes, organic acids, esters or ethers. Particularly advantageously, substances that can be produced by fermentation such as ethanol, butanol or acetone or mixtures thereof can be adsorbed and/or desorbed.

In another aspect, the present invention relates to the use of the granules as defined in more detail above for the adsorption of organic molecules from gases and liquids.

In a preferred embodiment, the use comprises the following steps:
a) contacting granules as defined above with a liquid or a gas containing at least one organic molecule;
b) desorption of the at least one organic molecule from the granules.

The contacting of the granules with the liquid or the gas can be carried out in any manner that is known by a person skilled in the art to be suitable for the purpose according to the invention. In a particularly preferred embodiment the granules are arranged in a column and the gas or the liquid is led through said column. Other preferred embodiments of the present invention relate to contacting the granules with the liquid or the gas in a fluidized bed.

The “liquid” is, in the context of the present invention, preferably an aqueous solution. In a particular embodiment it is a fermentation liquid. Fermentation liquids resulting from fermentation of a suitable fermentation medium containing a carbon source (e.g. glucose) and optionally a nitrogen source (e.g. ammonia) with for example one or more yeasts, bacteria or fungi, are particularly suitable. The yeasts Saccharomyces cerevisiae, Pichia stipitis, or microorganisms with similar fermentation properties such as for example Pichia segobiensis, Candida shehatae, Candida tropicalis, Candida boidinii, Candida tennis, Pachysolen tannophilus, Hansenula polymorpha, Candida famata, Candida parapsilosis, Candida rugosa, Candida sonorensis, Issatchenkia terricola, Kloeckera apis, Pichia barkeri, Pichia cactophila, Pichia deserticola, Pichia norvegensis, Pichia membranaefaciens, Pichia mexicana, Torulaspora delbrueckii, Candida bovina, Candida picachoensis, Candida emberorum, Candida pintolopesii, Candida thermophila, Kluyveromyces marxianus, Kluyveromyces fragilis, Kazachstania telluris, Issatchenkia orientalis, Lachancea thermotolerans, Clostridium thermocellum, Clostridium thermohydrosulphuricum, Clostridium thermosaccharolyticium, Thermoanaerobium brockii, Thermobacteroides acetoethylicus, Thermoanaerobacter ethanolicus, Clostridium thermoaceticum, Clostridium thermoautotrophicum, Acetogenium kivui, Desulfotomaculum nigrificans, and Desulfovibrio thermophilus, Thermoanaerobacter tengcongensis, Bacillus stearothermophilus and Thermoanaerobacter mathranii are particularly preferred. Suitable fermentation media are water-based media that contain biological raw materials such as wood, straw in undigested form or after digestion for example by enzymes. Other biological raw materials that can be used are cellulose or hemicellulose or other polysaccharides, which are also used either undigested, i.e. used directly, or previously cleaved by enzymes or some other pretreatment into smaller sugar units. However, in the context of the present invention it is also possible to use any type of liquid or mixtures of two or more liquids that contain the organic molecules to be adsorbed.

The “gas” in the context of the present invention is preferably air or one or more individual constituents of air, such as nitrogen, carbon dioxide and/or oxygen.

The “organic molecule” can in principle be any organic molecule, especially any organic molecule that is usually contained in fermentation liquids. The granules according to the invention are preferably used for the adsorption of low-molecular molecules with a molecular weight below 10 000 dalton, preferably below 1000 dalton, particularly preferably below 200 dalton. The use of the granules according to the invention is particularly suitable for the adsorption of low-molecular alcohols such as ethanol, butanol including 1-butanol, 2-butanol, isobutanol, t-butanol, propanediol including 1,2-propanediol, 1,3-propanediol, butanediol including 1,4-butanediol, 2,3-butanediol, of ketones such as acetone, and/or of organic acids such as acetic acid, formic acid, butyric acid, lactic acid, citric acid, succinic acid.

In a preferred embodiment of the method of the present invention, step a) of those described in more detail above is carried out at most until the adsorption capacity is exhausted. An embodiment of the use according to the invention is preferred in which a gas stream is circulated through the liquid, which contains at least one organic molecule, it is then contacted with the granules and is then recycled to the liquid.

In a preferred embodiment of the use according to the invention, the granules are arranged in a column. The arrangement of the granules in a column further lowers the counterpressure with which the granules oppose the liquid or the gas. Furthermore, the abrasion of the granules is greatly reduced.

In another preferred embodiment step a) and/or b) are carried out at a temperature from 20 to 35° C.

The “desorption” of the at least one organic molecule according to step b) can be carried out in any manner that is known by a person skilled in the art to be suitable. Desorption by raising the temperature of the granules and/or lowering the ambient pressure down to a vacuum is preferred. In a preferred embodiment the temperature during execution of step b) is raised to 35 to 70° C., more preferably 40 to 55° C. and most preferably 45 to 50° C. After desorption, the granules according to the invention can be reused for adsorption of organic molecules from gas(es) and/or liquid(s).

### Methods of Measurement

The physical properties of the zeolites, clay minerals and granules were determined by the following methods:

Determination of the Montmorillonite Content from the Adsorption of Methylene Blue

The methylene blue value is a measure for the internal surface area of clay materials.
a) Preparation of a tetrasodium diphosphate solution
5.41 g of tetrasodium diphosphate is weighed to an accuracy of 0.001 g in a 1000-ml graduated flask and, while shaking, is topped up to the calibration mark with distilled water.
b) Preparation of a 0.5% methylene blue solution
In a 2000-ml beaker, 125 g of methylene blue is dissolved in approx. 1500 ml of distilled water. The solution is decanted off and is made up to 25 l with distilled water.
0.5 g of moist test bentonite with known internal surface area is weighed in an Erlenmeyer flask to an accuracy of 0.001 g. 50 ml of tetrasodium diphosphate solution is added and the mixture is brought to the boil for 5 minutes. After cooling to room temperature, 10 ml of 0.5 molar H₂SO₄ is added and 80 to 95% of the expected final consumption of methylene blue solution is added. One drop of the suspension is taken up with a glass rod and put on filter paper. A blue-black spot with a colourless halo forms. Now further methylene blue solution is added in 1-ml portions and the spot test is repeated. Addition is continued until the halo turns slightly light blue, i.e. the methylene blue addition is no longer absorbed by the test bentonite.
c) Testing of clay materials
The clay material is tested in the same way as for the test bentonite. The internal surface area of the clay material can be calculated from the amount of methylene blue solution consumed.
By this method, 381 mg methylene blue/g clay corresponds to a content of 100% montmorillonite.

### BET Surface Area/Pore Volume by BJH and BET:

The surface area and the pore volume were determined with a fully automatic nitrogen porosimeter from the company Micromeritics, type ASAP 2010.

The sample is cooled under high vacuum to the temperature of liquid nitrogen. Then nitrogen is metered continuously into the sample chambers. An adsorption isotherm is determined at constant temperature by recording the amount of gas adsorbed as a function of the pressure. During pressure equalization, the analysis gas is removed progressively and a desorption isotherm is recorded.

To determine the specific surface area and the porosity according to the BET theory, the data are evaluated according to DIN 66131.

The pore volume is also determined from the measured data using the BJH method (I. P. Barret, L. G. Joiner, P. P. Haienda, J. Am. Chem. Soc. 73, 1991, 373). Capillary condensation effects are also taken into account in this method. Pore volumes of particular ranges of volumes are determined by summing incremental pore volumes that are obtained from the evaluation of the adsorption isotherm according to BJH. The total pore volume by the BJH method relates to pores with a diameter from 1.7 to 300 nm.

The proportion of mesopores and macropores was determined by mercury porosimetry (DIN 66133, Meso- and macropore distribution from 900 μm to 3 nm), cf. A. W. Adamson, A. P. Gast, Physical Chemistry on Surfaces, Wiley (1997) p. 577 and F. Ehrburger-Dolle, Fractal Characteristics of Silica Surfaces and Aggregates in: The Surface Properties of Silicas, Editor A. P. Legrand, Wiley (1998) p. 105.

### Determination of Cation Exchange Capacity (CEC) of Clays

Principle: The clay is treated with a large excess of aqueous NH₄Cl solution, elutriated, and the amount of NH₄⁺ remaining on the clay is determined by elemental analysis.

Me⁺(clay)⁻+NH₄⁺->NH₄⁺(clay)⁻+Me⁺

(Me⁺=H⁺, K⁺, Na⁺, ½ Ca²⁺, ½ Mg²⁺ . . . )

Equipment: sieve, 63 μm; Erlenmeyer flask with ground-glass joint, 300 ml; analytical balance; membrane suction filter, 400 ml; cellulose nitrate filter, 0.15 μm (from Sartorius); drying cabinet; reflux condenser; heating plate; distillation unit, VAPODEST-5 (from Gerhardt, No. 6550); graduated flask, 250 ml; flame AAS chemicals: 2N NH₄Cl solution Nessler reagent (from Merck, Art. No. 9028); boric acid solution, 2%; sodium hydroxide solution, 32%; 0.1 N hydrochloric acid; NaCl solution, 0.1%; KCl solution, 0.1%.

Procedure: 5 g of clay is sieved through a 63 μm sieve and dried at 110° C. Then exactly 2 g is weighed by difference on the analytical balance in the Erlenmeyer flask with ground-glass joint and 100 ml of 2N NH₄Cl solution is added. The suspension is boiled under reflux for one hour. In the case of bentonites with high CaCO₃ content there may be evolution of ammonia. In such cases NH₄Cl solution must be added until an ammonia odour is no longer perceptible. An additional check with moist indicator paper can also be carried out. After standing for approx. 16 h the NH₄⁺-bentonite is filtered off on a membrane suction filter and is washed with deionized water (approx. 800 ml) until it is largely ion-free. Detection of absence of NH₄⁺ ions in the wash water is carried out with the Nessler reagent that is sensitive to this. The washing time can vary between 30 minutes and 3 days depending on the type of clay. The elutriated NH₄⁺-clay is removed from the filter, dried at 110° C. for 2 h, ground, sieved (63 μm sieve) and dried again at 110° C. for 2 h. Then the NH₄⁺ content of the clay is determined by elemental analysis.

Calculation of the CEC: the CEC of the clay was determined conventionally from the NH₄⁺ content of the NH₄⁺-clay, which was found by elemental analysis of the N content. The Vario EL 3 instrument from the company Elementar-Heraeus, Hanau, Germany, was used for this, following the manufacturer's instructions. The results are given in meal/100 g clay (meq/100 g).

### Example

nitrogen content=0.93%;
molecular weight: N=14.0067 g/mol

$$CEC = \frac{0.93 \times 1000}{14.0067} = 66.4 m Val \text{/} 100 g$$

CEC=66.4 meq/100 g NH₄⁺-bentonite

### Determination of Water Content

The water content at 105° C. is determined using the method DIN/ISO-787/2.

### Determination of the pH of a Bentonite Sample

2 g of the sample is dispersed in 98 ml of distilled water. Then the pH is determined using a calibrated glass electrode.

### Loss on Ignition

In a calcined and weighed porcelain crucible with cover, approx. 1 g of dried sample is weighed to an accuracy of 0.1 mg and calcined for 2 h at 1000° C. in a muffle furnace. Then the crucible is cooled in a desiccator and weighed again.

### Determination of Dry Sieve Residue

About 50 g of the air-dry clay material under investigation is weighed on a sieve of the corresponding mesh size. The sieve is connected to a dust extractor, by which all fractions that are finer than the sieve are sucked out through the sieve, via a suction slot around the bottom of the sieve. The sieve is covered with a plastic cover and the dust extractor is switched on. After 5 minutes the dust extractor is switched off and the amount of coarser fractions left on the sieve is determined by weighing the difference.

### Determination of Bulk Density

A graduated cylinder, cut off at the 1000-ml mark, is weighed. Then the test sample is filled by means of a powder funnel in one operation into the graduated cylinder, so that a cone of material forms above the upper end of the graduated cylinder. Using a ruler, which is passed over the opening of the graduated cylinder, the cone of material is struck off and the filled graduated cylinder is weighed again. The difference corresponds to the bulk density.

### Characterization of the Zeolites Used

The zeolites were characterized using the following methods:

| Parameter | Method |
|---|---|
| Zeolite type | DIN EN 13925-1 and DIN EN |
| | 13925-2 (X-ray diffractometry) |
| Crystallinity | DIN EN 13925-1 and DIN EN |
| | 13925-2 (X-ray diffractometry) |
| Grain size, | ISO 13320 Particle size analysis - |
| d_{50%} | Laser diffraction methods |
| d_{90%} | |
| BET surface area | DIN 66131 |

### Production of Granules

The granules for the examples were prepared using an Eirich intensive mixer RO2E (from Gustav Eirich, Hartheim, Germany). For granule production, the powders were prepared, premixed, and a liquid granulating agent was gradually added through a funnel, according to the following examples. The lowest setting was selected for the rotary speed of the disk, and the maximum rotary speed for the cyclone. The particle sizes of the moist granules can be controlled by the choice of liquid granulating agent, the amount of the latter added and the rate of addition.

### Determination of the Compressive Strength (Breaking Strength) of the Granules

The compressive strength (breaking strength) of the granules was tested using a tablet hardness tester 8M from the company Dr. Schleuninger Pharmatron AG. For this, individual granules were placed using tweezers in the hollow between the jaws of the tester. For the test, a constant feed speed of 0.7 mm/s was used, until the pressure increased. Then a constant load increase of 250 N/s was set. The test results can be given to an accuracy of 1 N.

### EXAMPLES

The invention is described in more detail and clarified in the following examples. It is emphasized that the examples only serve for purposes of illustration and are not in any way limiting or restricting for the teaching according to the invention.

In the following examples, the zeolite granules according to the invention are produced by granulation with bentonite, followed by sintering. The clay minerals used as binder are described below.

### Characterization of the Clay Minerals Used as Binder for the Zeolite Granules

The following bentonites were used for granulation of the zeolites: bentonite 1 is a natural calcium/sodium bentonite. Bentonite 2 was prepared by mixing bentonite 1 with 4.3 wt.-% soda, then kneading, drying and grinding. The bentonites have a dry sieve residue of <15 wt.-% on a sieve of mesh size 45 μm and a residue of <7 wt.-% on a sieve of mesh size 75 μm. The properties of bentonites 1 and 2 used as starting materials are presented in Tables 1 and 2.

TABLE 1
Properties of bentonites 1 and 2 used as starting materials

| | Bentonite 1 | Bentonite 2 |
|---|---|---|
| Montmorillonite content, | 75 | 78 |
| determined by the methylene | | |
| blue method [%] | | |
| Cation exchange capacity | 76 | 72 |
| [meq/100 g] | | |
| Proportion of monovalentions | 20 | 100 |
| as percentage of total cation | | |
| exchange capacity | | |
| Swelling volume in distilled | 11 | >15 |
| water [ml/2 g) | | |

### Example 1

### Granules of MFI Zeolite with an SiO₂/Al₂O₃ Ratio of >800 and Bentonite

The granules were prepared using an MFI zeolite from Sud-Chemie AG, Bitterfeld, which had the following properties:

TABLE 2
Characteristic properties of the zeolite used

| Parameter | Unit | Value |
|---|---|---|
| Zeolite type | | MFI (monoclinic) |
| Crystallinity | % | 85 |
| Crystalline impurities | % | n.d. |
| Na₂O content | wt.-% | 0.7 |
| SiO₂/Al₂O₃ | | >800 |
| molar ratio | | |
| Grain size, | | |
| d_{50%} | μm | 10 |
| d_{90%} | | 15 |
| BET surface area | m² · g⁻¹ | 340 |

The zeolite powder was put in the Eirich mixer. In different batches, 10 wt.-% and 20 wt.-% of bentonite 1 or 2 were then added and premixed for 2 minutes. Then, slowly adding water, it was granulated to target particle sizes of 0.4-1.0 mm. The wet granules were in each case dried for 1 h at 80° C. in a circulating-air drying cabinet, sieved to particle sizes of 0.4-1 mm and then calcined for 1 h in a muffle furnace at 600° C. The formulations are shown in the following Table 3, and the characterization data in Table 4. Without adding binders, it is not possible to granulate the zeolite powder. In this case only a paste is obtained.

TABLE 3
Formulations of zeolite MFI granules

| | Weight of | | | |
|---|---|---|---|---|
| | MFI zeolite | | | Weight of |
| | (according | Weight of | Weight of | water for |
| Formulation | to Table 2) | bentonite 1 | bentonite 2 | granulation |
| No. | [g] | [g] | [g] | [g] |
| 1 | 800 | — | 200 | 320 |
| 2 | 900 | — | 100 | 345 |
| 3 | 800 | 200 | — | 292 |
| 4 | 900 | 100 | — | 338 |

TABLE 4
Properties of the zeolite granules

| | Bulk density | BET surface area |
|---|---|---|
| Formulation No. | [g/l] | [m²/g] |
| 1 | 671 | 275 |
| 2 | 602 | 298 |
| 3 | 649 | 322 |
| 4 | 580 | 294 |
| Comparative value | n.d. | 336 |
| Initial zeolite powder | | |

For the granules of formulation No. 4, additionally the compressive strength (breaking strength) was determined. The average of 20 measurements gave a value of 26±9 N.

### Example 2

### Granules of MFI Zeolite with an SiO₂/Al₂O₃ Ratio of 200

As in example 2, granules were prepared from another MFI zeolite. This had an SiO₂/Al₂O₃ ratio of 200. The procedure for preparing the granules according to the invention was the same as in example 2. Various proportions of bentonite 1 were used as binder for the systems according to the invention. In comparative examples, no bentonite was added, but granulation was performed with various dilutions of silica sol (Baykiesol, Lanxess).

TABLE 5
Formulations for granules with zeolite TZP 2524

| | Weight of | Weight of | Water | Water/ | Water/ |
|---|---|---|---|---|---|
| Formula- | zeolite | bentonite 1 | for granu- | Baykiesol | Baykiesol |
| tion No. | [g] | [g] | lation | 1:1 | 5:1 |
| 5 | 900 | 100 | 336 | | |
| 6 | 800 | 200 | 324 | | |
| 7 | 850 | 150 | 316 | | |
| 8 | 850 | 150 | — | | 322 |
| 9 | 900 | — | — | 373 | |

### Example 3

### Adsorption Tests in Aqueous Solution

In each case 150 mg of the granules according to the invention (formulation 4 from Table 4) and of the ungranulated zeolite powder are weighed in Eppendorf caps. Then 1.5 mL of a 5% (w/v) ethanol solution is added in each case. Then it is shaken into suspension for one hour at 23° C. and 1200 rpm. Then the solid is separated by centrifugation and the supernatant is analysed by gas chromatography. From the comparison of the ethanol concentrations before and after the test, the loading of the solid is determined via a mass balance. Table 6 shows the values obtained.

TABLE 6
Adsorption of ethanol in the aqueous phase

| | Loading | Relative loading |
|---|---|---|
| | [%(w/w)] | [%] |
| Zeolite powder | 8.63 +/− 0.09 | 100 |
| Granules according | 7.26 +/− 0.05 | 84.1 |
| to the invention | | |
| (formulation 4 from | | |
| Table 4) | | |

The same experiment for butanol instead of ethanol gives the results shown in Table 7.

TABLE 7
Adsorption of butanol in the aqueous phase

| | Loading | Relative loading |
|---|---|---|
| | [%(w/w)] | [%] |
| Zeolite powder | 10.33 +/− 0.11 | 100 |
| Granules according | 9.61 +/− 0.09 | 93.0 |
| to the invention | | |
| (formulation 4 from | | |
| Table 4) | | |

The same experiment for acetone instead of butanol gives the results shown in Table 8.

TABLE 8
Adsorption of acetone in the aqueous phase

| | Loading | Relative loading |
|---|---|---|
| | [%(w/w)] | [%] |
| Zeolite powder | 9.89 +/− 0.06 | 100 |
| Granules according | 8.29 +/− 0.08 | 83.8 |
| to the invention | | |
| (formulation 4 from | | |
| Table 4) | | |

### Example 4

### Adsorption Tests in the Gas Phase

In a closed system, nitrogen is injected by a membrane pump into a wash bottle filled with pure ethanol and is dispersed over a glass frit. The resultant ethanol-laden gas then goes into a glass column, which contains 90 g of the granules according to the invention or of ungranulated zeolite powder. After this column, the gas is pumped back into the wash bottle by the membrane pump. It is known from preliminary tests that the maximum loading is reached within 24 hours. After 24 hours, the test is ended and the weight increase is determined. The capacity of the material can be calculated taking into account the weight of carrier used. Table 9 shows the results obtained.

TABLE 9
Adsorption of ethanol in the gas phase

| | Loading | Relative loading |
|---|---|---|
| | [%(w/w)] | [%] |
| Zeolite powder | 9.81 | 100 |
| Granules according | 9.67 | 98.6 |
| to the invention | | |
| (formulation 4 from | | |
| Table 4) | | |

The same experiment for water instead of ethanol gives the results shown in Table 10.

TABLE 10
Adsorption of water from the gas phase

| | Loading | Relative loading |
|---|---|---|
| | [%(w/w)] | [%] |
| Zeolite powder | 0.83 | 100% |
| Granules according | 0.66 | 79% |
| to the invention | | |
| (formulation 4 from | | |
| Table 4) | | |

### Example 5

### Production of Zeolite Granules with Special Steel Powder as Additional Component

Similarly to example 1, zeolite granules were prepared with special steel powder as additional component, with granulation again being carried out with water as in example 1.

For this, the special steel powder with the designation “54650 Stainless Steel Powder” from Kramer Pigmente, D-88317 Aichstetten, Allgau was used. The steel powder had the following characteristic properties (Table 11) (according to manufacturer's information):

TABLE 11
Properties of “54650 Stainless Steel Powder”

| | | |
|---|---|---|
| Bulk density | 2.80 | g/cm³ |
| Fe content | 99 | wt.-% |
| Content of metallic iron | 98.5 | wt.-% |
| O content | 0.5 | wt.-% |
| C content | 0.02 | wt.-% |
| Sieve analysis | | |
| >150 μm | 0 | wt.-% |
| 75-150 μm | 2 | wt.-% |
| >45 μm | 80 | wt.-% |

The same MFI zeolite as in example 1 (SiO₂/Al₂O₃ ratio of >800, see Table 2) and bentonite 1 were used as further granulation components.

The composition of the granulation formulation is presented in the following table.

TABLE 12
Composition of the granulation formulation

| Weight of | | | |
|---|---|---|---|
| MFI zeolite | | | Weight of |
| (according to | Weight of | Weight of | water for |
| Table 2) | bentonite 1 | steel powder | granulation |
| [g] | [g] | [g] | [g] |
| 800 | 100 | 100 | 342 |

After drying and calcining at 600° C. for 1 h, stable steel-containing zeolite granules were obtained. The fraction with particle sizes of 0.6-2 mm had a bulk density of 630 g/l.

1. Granules comprising at least one zeolite and at least one clay mineral with a cation exchange capacity of at most 200 meq/100 g, wherein the proportion of monovalent ions in the cation exchange capacity of the at least one clay mineral is at most 50%.

2. Granules according to claim 1, wherein the at least one zeolite has an SiO₂: Al₂O₃ ratio of >200.

3. Granules according to claim 1, wherein the at least one clay mineral is a sheet silicate.

4. Granules according to claim 3, wherein the sheet silicate is a smectitic sheet silicate.

5. Granules according to claim 3, wherein the sheet silicate is a mineral of the talc-pyrophyllite group.

6. Granules according to claim 3, wherein the sheet silicate is a natural or artificial mixture of a clay of the talc-pyrophyllite group and a smectitic clay.

7. Granules according to claim 1, wherein the proportion of the at least one clay mineral is at most 20 wt.-%.

8. Granules according to claim 1, wherein the proportion of monovalent ions in the cation exchange capacity of the at least one clay mineral is at most 60%.

9. Granules according to claim 1, wherein the proportion of divalent ions in the cation exchange capacity of the at least one clay mineral is at least 40%.

10. Granules according to claim 1, wherein the granules have an average size from 1 to 7 mm with monomodal distribution.

11. Granules according to claim 1, wherein the zeolite is selected from the group consisting of f3-zeolite, silicalite, mordenite, Y-zeolite, USY, MFI zeolite and mixtures thereof.

12. Granules according to claim 1, wherein the granules have a D50 value of at least 0.5 mm.

13. Granules according to claim 1, wherein the granules have a BET specific surface area from 200 to 600 m³/g.

14. Granules according to claim 1, wherein the at least one clay mineral has a ratio of divalent ions Ca⁺ and Mg⁺ to monovalent ions, as total of Na⁺+K⁺+Li⁺, between 1:2 and 20:1.

15. Granules according to claim 1, wherein the granules additionally comprise a proportion of metal powder from 0.01 to 20 wt.-%.

16. Use of the granules as defined in claim 1, for adsorption of organic molecules from gases and liquids.

17. Use of the granules as defined in claim 1, for adsorption of organic molecules from gases and liquids, comprising the following steps:
a) contacting the granules with a liquid or a gas containing at least one organic molecule;
b) desorption of the at least one organic molecule from the granules.

18. Use according to claim 17, wherein the granules are arranged in a column.
